(19) United States
(12) Patent Application Publication
(10) Pub. No.: US 2009/0104972 A1
(43) Pub. Date: Apr. 23, 2009

(54) Gaming Machine

(75) Inventors: Takehisa ITAGAKI, Tokyo (JP); Masahiko KONISHI, Tokyo (JP); Syunichiro KURIHARA, Tokyo (JP); Hiroyuki YAMADA, Tokyo (JP); Toshiaki OHKUBO, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Toyko (JP)

(21) Appl. No.: 12/252,937

(22) Filed: Oct. 16, 2008

(30) Foreign Application Priority Data
Oct. 19, 2007 (JP) 2007-272860

(51) Int. Cl. A63F 9/24; A63F 13/00

(52) U.S. Cl. 463/20

(57) ABSTRACT

A slot machine executes a special effect process when a predetermined condition is satisfied. In the special effect process, a main CPU changes a display style of a stopped multi symbol from a first display style to a second display style, while displaying an effect character image on a variable display portion. Further, the effect character image is displayed while being overlapped with a part of symbol display areas, while maintaining a state in which most of figures of stopped symbols can be seen.

### CROSS-REFERENCE TO RELATED APPLICATIONS

This application is based upon and claims a priority from the prior Japanese Patent Application No. 2007-272860 filed on Oct. 19, 2007, the entire contents of which are incorporated herein by reference.

### BACKGROUND

1. Field

The present invention relates to a gaming machine that variably displays and stops symbols on a display, and more particularly, to a gaming machine that executes an effect on a display after symbols are stopped.

2. Description of Related Art

Conventionally, a gaming machine that has a symbol display portion for variably-displaying and stopping a plurality of symbols (for example, a gaming machine disclosed in U.S. Pat. No. 6,517,433) has been known. The gaming machine variably displays symbols and stops the symbols based on a determined game result on a display. Thereby, the gaming machine can notify a player of the game result.

In a gaming machine of this kind, an effect image may be displayed on the display. The gaming machine executes various types of effects on the basis of the effect image. As a result, various effect expressions as well as a simple variable display and stop of symbols are enabled. Therefore, the gaming machine of this kind can considerably improve an entertainment property in the gaming machine.

In the gaming machine, the stop of symbols serves to notify a player of a game result. Accordingly, in the above-described conventional gaming machine, an effect using an image after stopping the symbols is executed only in the areas of the display except symbol display portions where the symbols are stopped. In this case, in the gaming machine, an effect to be executed after the symbols are stopped is restricted in terms of its variety. As a result, the gaming machine causes a game to be monotonous and an interest of a player to be lowered.

Accordingly, the invention has been made in consideration of the above-described problems, and it is an object of the invention to provide a gaming machine that variably displays and stops symbols on a display. It is another object of the invention to provide a gaming machine that can execute an effect after symbols are stopped for enhancing an interest of a player without lowering the visibility of a game result.

### SUMMARY

Therefore, in order to achieve the object, according to a first aspect of the present invention, there is provided a gaming machine comprising: a display that displays a symbol display portion on which plural kinds of symbols are variably displayed and stopped; and a processor that executes: (a) a process of starting variable-display of the plurality of symbols, stopping the variable-display of the plurality of symbols and display symbols among from the plurality of symbols in the symbol display portion; (b) a process of determining one game result; (c) a process of, when a predetermined condition is satisfied, displaying an effect image for an effect on the display with overlapped with a part of the symbol display portion while keeping each of the symbol s stopped at the process (a) visible; (d) a process of executing an effect using the effect image displayed while being overlapped with a part of the symbol display portion; and (e) a process of awarding a prize based on the game result currently determined.

The gaming machine variably displays and stops the symbols. The gaming machine executes a game where a prize is awarded on the basis of the symbols that are displayed as a game result. In this case, the gaming machine executes an effect using an effect image after the game result is notified to a player by the stop of the symbols. The effect image is displayed on a display while maintaining a state where each of the stopped symbols can be seen. As a result, the gaming machine can execute an effect using an effect image without disturbing the grasp of the game result by the player. The effect image is displayed on the display while being overlapped with a part of the symbol display portion. That is, an area that can be used for the effect using an effect image is increased. Accordingly, the gaming machine can execute an effect using even more various effect images. As a result, the gaming machine can enhance an interest of the player.

According to one or more aspects of the present invention, there is provided a gaming machine comprising: a display that displays a symbol display portion on which plural kinds of symbols are variably displayed and stopped; and a processor that executes: (a) a process of starting variable-display of the plurality of symbols, stopping the variable-display of the plurality of symbols and display symbols among from the plurality of symbols in the symbol display portion; (b) a process of determining one game result; (c) a process of, when a predetermined condition is satisfied, displaying an effect image for an effect on the display with overlapped with a part of the symbol display portion while keeping each of the symbol s stopped at the process (a) visible; (d) a process of executing an effect for changing a display style of the symbols stopped at the process (a) to a display style determined depending on the game result, by using the effect image overlapped with the part of the symbol display portion at the process (c); (e) a process of awarding a prize based on the game result currently determined.

The gaming machine executes an effect using an effect image after a game result is notified to the player by the stop of symbols. The effect image is displayed on the display while maintaining a state where each of the stopped symbols can be seen. As a result, the gaming machine can execute an effect using an effect image without disturbing the grasp of the game result by the player. The effect image is displayed on the display while being overlapped with a part of the symbol display portion. As a result, an area that can be used for an effect using an effect image increases. Accordingly, the gaming machine can execute an effect using various types of effect images. As a result, the gaming machine can enhance an interest of the player. Also, the gaming machine uses the effect image to execute an effect of changing a display style of the currently stopped symbols to a display style based on the game result. Accordingly, the gaming machine can provide an interest of “amazement by a change based on the effect” to the player.

According to one or more aspects of the present invention, there is provided a gaming machine comprising: a display that displays a symbol display portion on which plural kinds of the symbols including a special symbol are variably displayed and stopped; and a processor that executes: (a) a process of starting variable-display of the plurality of symbols, stopping the variable-display of the plurality of symbols and display symbols among from the plurality of symbols in the symbol display portion; (b) a process of determining one game result; (c) a process of, when a specific combination including the specific symbol is stopped on the symbol display portion, displaying an effect image for an effect on the display with overlapped with a part of the symbol display portion while keeping each of the symbols stopped at the process (a) visible; (d) a process of executing an effect for changing a display style of the special symbols stopped at the process (a) to a display style determined depending on the game result, by using the effect image overlapped with the part of the symbol display portion at the process (c); and (e) a process of awarding a prize based on the game result currently determined.

The gaming machine executes an effect using an effect image after a game result is notified to the player by the stop of symbols. The effect image is displayed on the display while maintaining a state where each of the stopped symbols can be seen. As a result, the gaming machine can execute an effect using an effect image without disturbing the grasp of the game result by the player. The effect image is displayed on the display while being overlapped with a part of the symbol display portion. As a result, an area that can be used for an effect using an effect image increases. Accordingly, the gaming machine can execute an effect using various types of effect images. As a result, the gaming machine can enhance an interest of the player. Also, the gaming machine uses the effect image to execute an effect of changing a display style of the currently stopped special symbols to a display style based on the game result. Accordingly, the gaming machine can provide an interest of “amazement by a change in the special symbols based on the effect” to a player.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is an explanatory view illustrating effect contents in a variable display portion based upon a special effect process;

FIG. 2 is a perspective view of a slot machine;

FIG. 3 is an explanatory view illustrating reel display portions of the slot machine;

FIG. 4 is an explanatory view illustrating symbol display areas of the slot machine;

FIG. 5 is a block diagram illustrating an internal constitution of the slot machine;

FIG. 6 is a block diagram illustrating an internal constitution of the sub control board of the slot machine;

FIG. 7 is an explanatory view illustrating normal symbols constituting each reel of the slot machine;

FIG. 8 is an explanatory view with respect to a multi symbol constituting each reel;

FIG. 9 is an explanatory view illustrating a symbol column constituting each reel of the slot machine;

FIG. 10 is an explanatory view illustrating a variable display portion upon variable display of symbols;

FIG. 11 is an explanatory view illustrating a variable display portion upon stop and display of symbols;

FIG. 12 is an explanatory view illustrating a payout table of the slot machine;

FIG. 13 is a flow chart of a main control process program;

FIG. 14 is a flow chart of a main game process program;

FIG. 15 is an explanatory view illustrating a table associating code numbers and symbols in the slot machine;

FIG. 16 is an explanatory view illustrating a table associating random number values and code numbers in the slot machine;

FIG. 17 is a flow chart of a special effect process program;

FIG. 18 is an explanatory view illustrating a bonus ratio determination table in the slot machine;

FIG. 19 is an explanatory view illustrating a variable display portion upon an effect character image display process;

FIG. 20 is an explanatory view illustrating a variable display portion upon an effect character image change process;

FIG. 21 is an explanatory view illustrating a variable display portion upon a multi symbol display change process; and

FIG. 22 is an explanatory view illustrating a variable display portion upon a bonus ratio notification process.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine according to one or more aspects of the invention will be described in detail with reference to the drawings based on an embodiment embodying one or more aspects of the invention. However, it is appreciated that one or more aspects of the present invention may be embodied in distributable (via CD and the like) or downloadable software games, console games, and the like. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU” and “processor” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

Hereinafter, concerning with a gaming machine according to the present invention, a slot machine 1 embodying the present invention is described in detail with reference to the accompanying drawings.

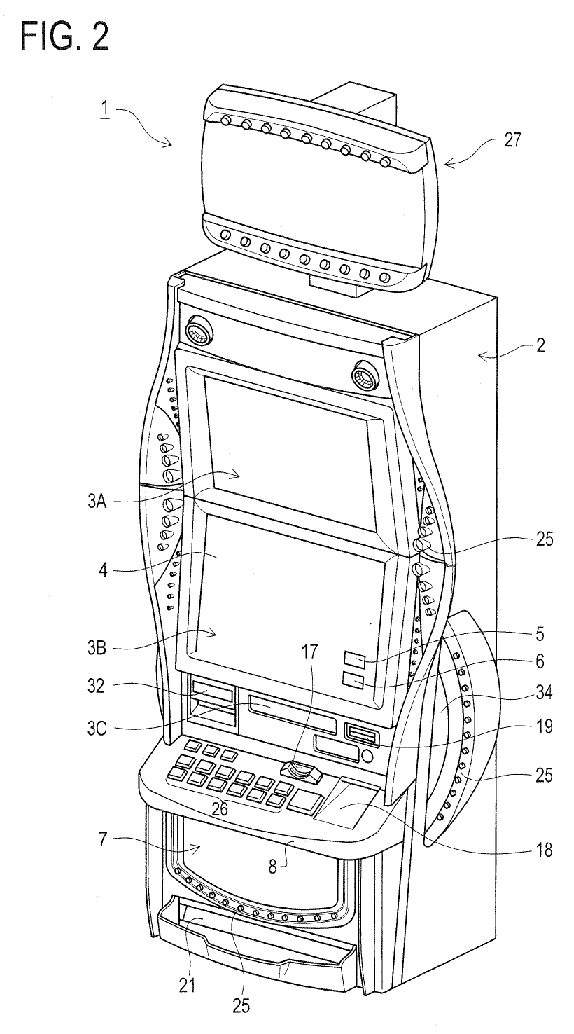

As shown in FIG. 2, a slot machine according to this embodiment includes an image display device, such as a liquid crystal display. In addition, in the slot machine, the image display device displays images of various types of symbols, thereby executing a game. That is, the slot machine is a so-called video slot machine.

A slot machine 1 according to this embodiment allows eleven kinds of multi symbols 50 (that is, a multi-treasure symbol 50B through a multi-ace symbol SOL) in addition to twelve kinds of normal symbols (that is, a feature symbol 45A through an ace symbol 45L) to be variably displayed and stopped on a variable display portion 3B. In addition, a content of a prize that is awarded to a player is determined according to the number of same kind of symbols that are stopped on the variable display portion 3B.

In this case, when the multi symbols 50 are stopped on the variable display portion 3B and fifteen symbols that are stopped on the variable display portion 3B satisfy a predetermined condition, the slot machine 1 according to this embodiment executes a special effect process (S17) after the symbols are stopped.

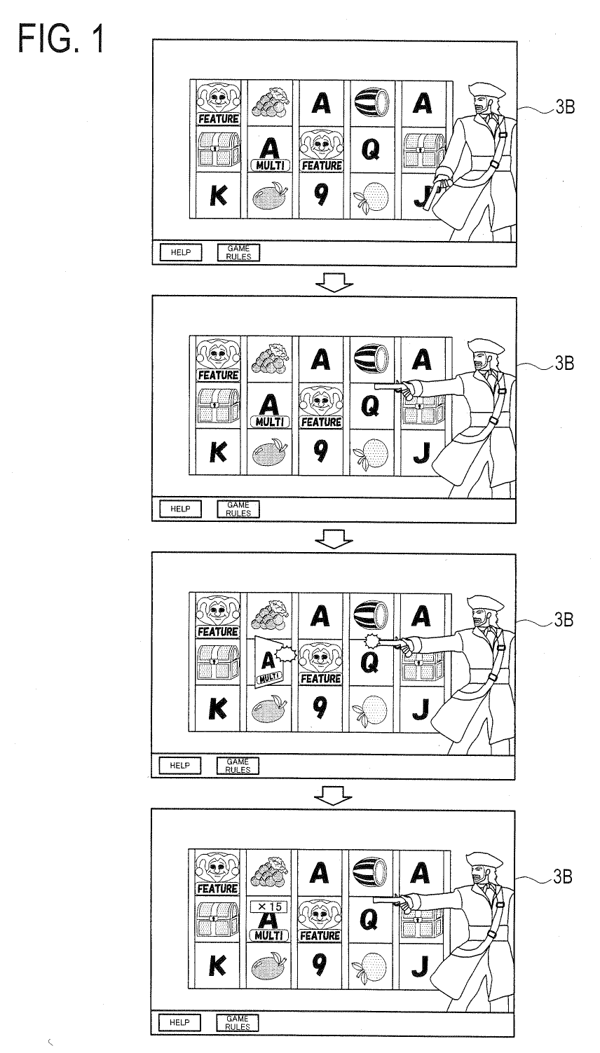

During the special effect process (S17), an effect character image 90 depicting a captain of a pirate ship is displayed on the variable display portion 3B. In addition, an effect using the effect character image 90 is executed. Specifically, in the special effect process (S17), first, an image of the effect character image 90 aiming a gun at a target is displayed on the variable display portion 3B. After that, an image of the effect character image 90 aiming a gun shoots the stopped multi symbol 50 is displayed on the variable display portion 3B. In conjunction with this, the slot machine 1 changes a display style of the multi symbol 50 from a later-described first display style to a later-described second display style (refer to FIGS. 1 and 19 through 22).

In the special effect process (S17), the effect character image 90 is displayed on the variable display portion 3B. The effect character image 90 slightly overlaps with a symbol display area where one symbol is stopped even at any point of time while the effect is executed (refer to FIGS. 1 and 19 through 22). Accordingly, during the special effect process (S17), most parts of the symbols that constitute a game result are not hidden by the effect character image 90. That is, the symbols are maintained such that their kinds can surely be seen. As a result, in the special effect process (S17), the slot machine 1 can execute an effect using the effect character image 90 while allowing the game result to be grasped. Accordingly, the slot machine 1 can enhance an interest of a player.

Next, the schematic configuration of the slot machine 1 according to this embodiment will be described in detail with reference to the accompanying drawings. FIG. 2 is a perspective view illustrating the exterior of the slot machine 1 according to this embodiment.

The slot machine 1 according to this embodiment is an upright-typed slot machine that is installed in a game arcade, such as a casino. The exterior of the slot machine 1 that is shown in FIG. 2 is only exemplary and the invention is not limited thereto.

As shown in FIG. 2, the slot machine 1 has a cabinet 2. The cabinet 2 is an accommodating portion that accommodates electrical or mechanical components to execute a predetermined game state.

In addition, the slot machine 1 includes an upper display portion 3A, a variable display portion 3B, and a lower display portion 3C, which are provided on a front surface of the cabinet 2. The upper display portion 3A, the variable display portion 3B, and the lower display portion 3C display various types of game information.

The upper display portion 3A is composed of a liquid crystal panel. In addition, the upper display portion 3A is arranged at an upper portion of the cabinet 2. The upper display portion 3A displays an effect image, a payout table during a game, a game rule, and so on.

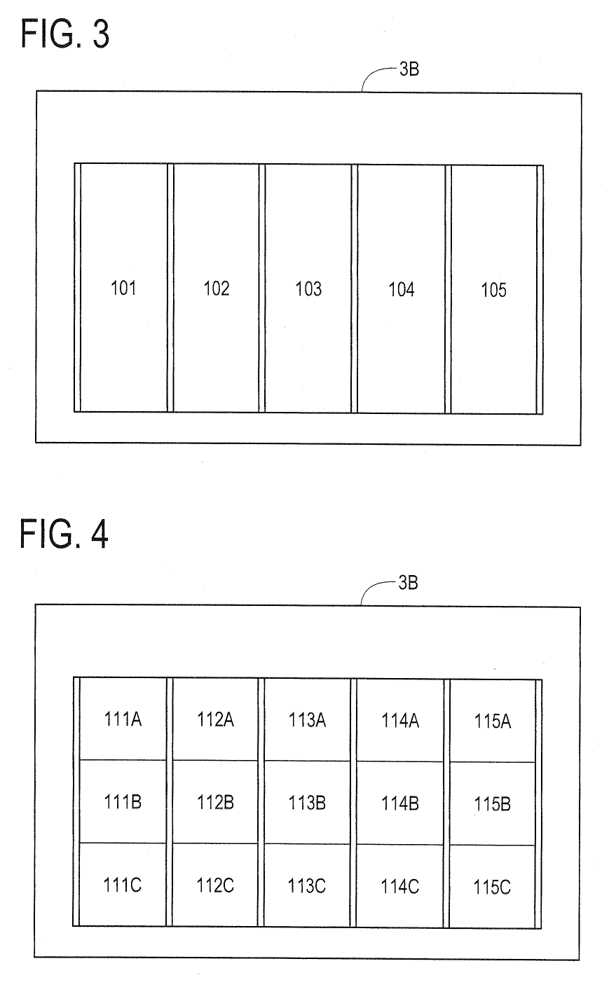

The variable display portion 3B is composed of a liquid crystal panel. The variable display portion 3B is arranged at a middle portion of the cabinet 2. In addition, the variable display portion 3B has five reel display portions 101 through 105 (refer to FIG. 3). A symbol column is variably displayed and stopped on each of the reel display portions. Each of the reel display portions 101 through 105 has three symbol display areas. Specifically, the reel display portions 101 through 105 have symbol display areas 111A through 111C, 112A through 112C, 113A through 113C, 114A through 114C, and 1155 through 115C, respectively. In addition, each of the symbol display areas displays a symbol (refer to FIG. 4). That is, the variable display portion 3B displays fifteen symbols in a matrix of 3×5. Here, the number of reels and the number of displayed symbols in each reel display portion are variable.

That is, the “symbol display portion” according to the embodiment of the invention includes the five reel display portions 101 through 105. In other words, the “symbol display portion” includes fifteen symbol display areas.

A touch panel 4 is provided on a front surface of the liquid crystal panel of the variable display portion 3B. A player can input various instructions by operating the touch panel 4. Further, a payout amount display portion 5 and a credit amount display portion 6 are provided in a lower right part of the variable display portion 3B. The display position to arrange the payout amount display portion 5 and the credit amount display portion 6 can be determined arbitrarily. A bet amount display portion may further be provided in the variable display portion 3B to display a bet amount. The payout amount display portion 5 displays a payout amount awarded to a player (i.e., a payout amount awarded by satisfying a predetermined condition at a base game and the accumulated payout amount acquired during a free game). In addition, the credit amount display portion 6 displays a current credit amount that the player currently possesses.

The lower display portion 3C is composed of a liquid crystal panel. The lower display portion 3C is arranged at a lower portion of the cabinet 2. The lower display portion 3C displays a game point amount or a point amount that is recorded in a card. When the card is not inserted or not read, the lower display portion 3C displays a message informing this fact.

A card reading portion 19 is arranged near the lower display portion 3C. The card reading portion 19 reads out information that is recorded in a card that is possessed by a player.

As described above, in this embodiment, each of the upper display portion 3A, the variable display portion 3B, and the lower display portion 3C is composed of a liquid crystal display, but the invention is not limited thereto. For example, each of the upper display portion 3A, the variable display portion 3B, and the lower display portion 3C may be composed of any one of a CRT display, a plasma display, an LED display, and other known display devices.

A lower panel 7 is arranged below the lower display portion 3C. The lower panel 7 is composed of a plastic panel on which a picture of a character related to the slot machine 1 or a name of the slot machine 1 is drawn. The lower panel 7 is illuminated by a backlight. The lower panel 7 may be composed of any one of a liquid crystal display, a CRT display, a plasma display, an LED display, and other known display devices.

An operation table 8 is provided below the variable display portion 3B. Various operation buttons 26 (for example, an exchange button, a payout button, a help button, a BET button, and a start button) are arranged in the operation table 8. Further, a coin insertion portion 17 and a bill insertion portion 18 are arranged in the operation table 8.

The position to arrange the respective types of operation buttons can be determined arbitrarily. As necessary, one portion of the respective operation buttons may be eliminated or buttons may be newly added or replaced.

In addition, a coin payout portion and a coin tray 21 are formed in a lower portion of the cabinet 2. The coin payout portion is serves to payout coins when the exchange button or the payout button is operated. The coin tray 21 serves to receive coins that were paid out from the coin payout portion. The coin detecting portion is composed of a sensor or the like. The coin detecting portion detects the number of coins that are paid out through the coin payout portion.

Further, light emitting portions 25 are arranged around the cabinet 2 of the slot machine 1. When a player wins a prize or plays a bonus game, the light emitting portion 25 lights in a predetermined lighting state. A speaker 34 for audio output is provided at a side face of the cabinet 2. The position to arrange the light emitting portion 25 and the speaker 34 can be determined arbitrarily.

As shown in FIG. 2, the slot machine 1 has a topper effect device 27 at the upper portion of the cabinet 2. The topper effect device 27 has a rectangular board shape. The topper effect device 27 is arranged to be substantially parallel to the upper display portion 3A. The topper effect device 27 displays various types of information. The shape of the topper effect device 27 can be designed arbitrarily.

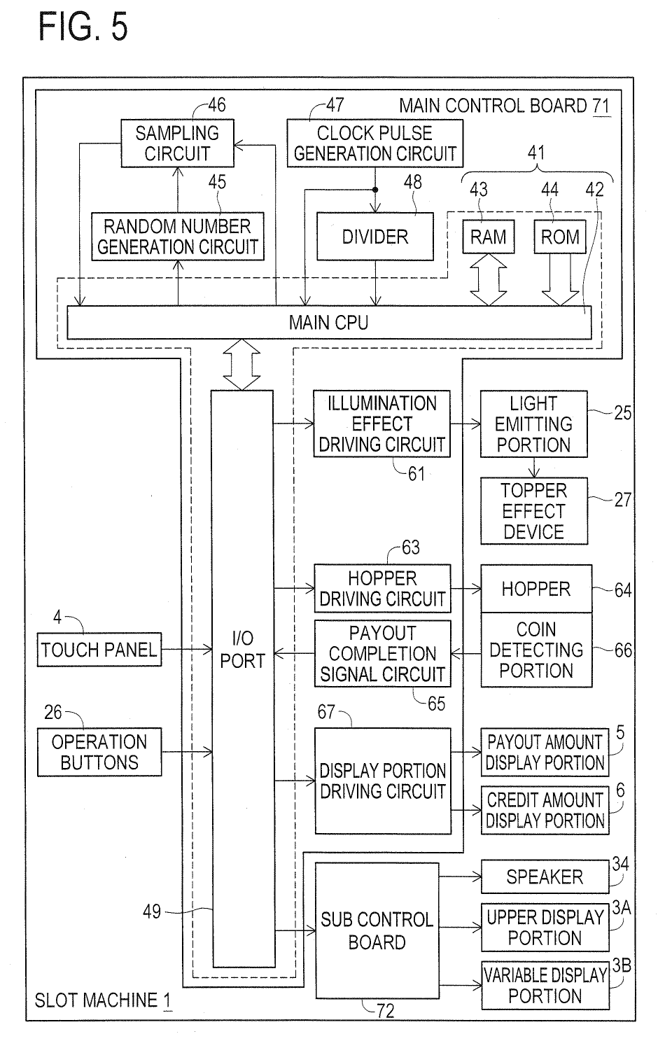

Next, the internal configuration of the slot machine 1 will be described in detail with reference to the accompanying drawings. FIG. 5 is a block diagram illustrating the entire internal configuration of the slot machine 1. As shown in FIG. 5, the slot machine 1 includes a main control board 71 having a controller 41 as a functions core. Further, the slot machine 1 has a plurality of constituent elements. The main control board 71 includes the controller 41, a random number generation circuit 45, a sampling circuit 46, a clock pulse generation circuit 47, a divider 48, an illumination effect driving circuit 61, a hopper driving circuit 63, a payout completion signal circuit 65, and a display portion driving circuit 67.

The controller 41 has a main CPU 42, a RAM 43, and a ROM 44. The main CPU 42 operates in accordance with a program that is stored in the ROM 44, and executes a signal input/output operation with other constituent elements through an I/O port 49. As a result, the main CPU 42 controls the operation of the entire slot machine 1. The RAM 43 stores data or a program that is used when the main CPU 42 operates. For example, the RAM 43 temporarily stores a random number value that is sampled by the sampling circuit 46 after a game starts. The RAM 43 stores code numbers that correspond to the reel display portions 101 through 105. In addition, the ROM 44 stores various control programs that are executed by the main CPU 42 and permanent data.

The programs that are stored in the ROM 44 include a game program and a game system program (hereinafter, all of which are simply referred to as a game programs). The game program includes a lottery program.

The lottery program is executed when determining code numbers corresponding to the symbols that are stopped at the middle portion of the reel display portions 101 through 105 of the variable display portion 3B (that is, symbol display areas 111B, 112B, 113B, 114B, and 115B).

This lottery program includes symbol weighing data. The symbol weighing data shows correspondence relationships between the respective code numbers and one or a plurality of random number values within a predetermined number value range. The probability of lottery with respect to each symbol on the reel band is set by associating one or a plurality of random number values to one code number. The random number values are drawn by lottery and symbols which are identified as final from the random number values are displayed in a predetermined area on the variable display portion 3B.

The random number generation circuit 45 is operated in accordance with an instruction from the main CPU 42, and generates random numbers in a predetermined range. The sampling circuit 46 extracts an arbitrary random number from the random numbers that are generated by the random number generation circuit 45, in accordance with an instruction from the main CPU 42. In addition, the sampling circuit 46 inputs the extracted random number to the main CPU 42. The clock pulse generation circuit 47 generates a reference clock that is used to operate the main CPU 42. The divider 48 inputs the signals, which are obtained by dividing the reference clock at a predetermined length of cycle, to the main CPU 42.

The touch panel 4 is connected to the main control board 71. As described above, the touch panel 4 is arranged on a front surface of the variable display portion 3B. Then, the touch panel 4 specifies a coordinate position of a portion of the touch panel 4 that a player contacts. Accordingly, the touch panel 4 can judge the operations by the player (for example, a portion of the touch panel that the player contacts or a direction in which a position of the touch panel that the player contacts moves) on the basis of information of the specified coordinate position. In addition, a signal according to the judgment result is input to the main CPU 42 through the I/O port 49.

The operation buttons 26 (e.g., above-mentioned start button) that instruct the execution of a game are connected to the main control board 71 through an operation switches. Accordingly, a signal in accordance with a depression operation of the operation button 26 is input to the main CPU 42 through the I/O port 49.

The illumination effect driving circuit 61 executes an illumination effect on the light emitting portions 25 and the topper effect device 27 by outputting an effect signal according to the instruction from the main CPU 42. The topper effect device 27 is connected to the illumination effect driving circuit 61 through the light emitting portion 25.

The hopper driving circuit 63 drives a hopper 64 under the control of the main CPU 42. Accordingly, the hopper 64 executes a predetermined operation, and pays out the coins to the coin payout portion. The coin detecting portion 24 counts a number of coins that are paid out from the hopper 64. In addition, the coin detecting portion 24 inputs coin amount data which indicates the amount of coins that was detected to the payout completion signal circuit 65. The payout completion signal circuit 65 receives the coin amount data from the coin detecting portion 24. When the received coin amount becomes a predetermined coin amount, the payout completion signal circuit 65 inputs a signal that notifies coin payout completion to the main CPU 42. In addition, the display portion driving circuit 67 controls the display operations of various display portions including the payout amount display portion 5 and the credit amount display portion 6 and the like.

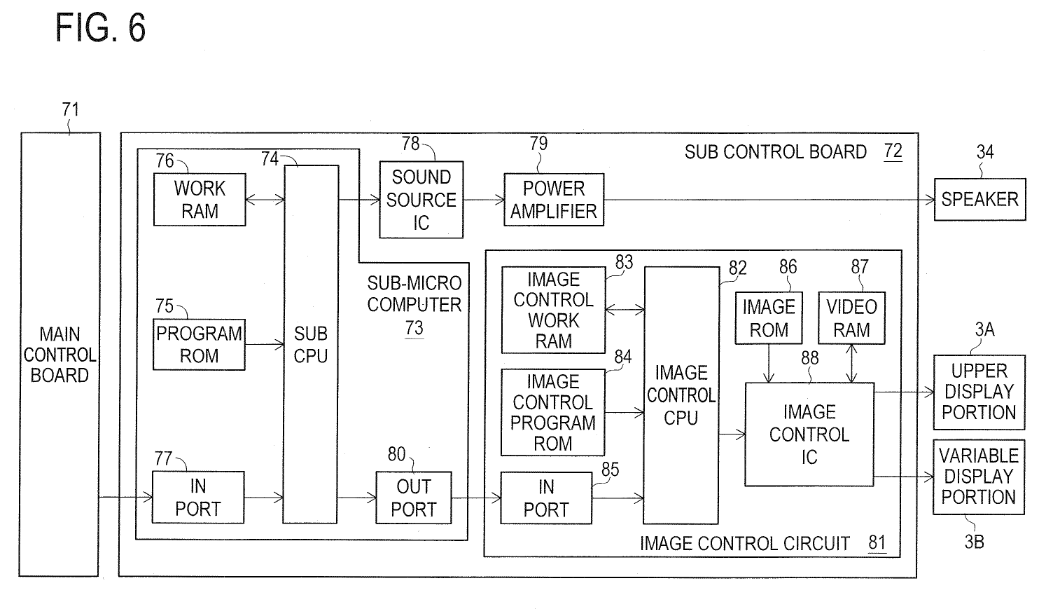

Further, the sub control board 72 is connected to the main control board 71. As shown in FIG. 6, the sub control board 72 controls a display of each display portion and the audio output from the speaker 34 in accordance with a command input from the main control board 71. The sub control board 72 is provided on a circuit board that is provided separately from a circuit board that constitutes the main control board 71. The sub control board 72 has a microcomputer (hereinafter, referred to as “sub-micro computer 73”) that functions as a main component. The sub control board 72 includes a sound source IC 78, a power amplifier 79, and an image control circuit 81. The sound source IC 78 controls the audio output from the speaker 34. The power amplifier 79 functions as an amplifier that amplifies a audio output from the speaker 34. The image control circuit 81 functions as a display control device of the upper display portion 3A and the variable display portion 3B.

The sub-micro computer 73 includes a sub CPU 74, a program ROM 75, a work RAM 76, and I/O ports 77 and 80. The sub CPU 74 executes a control operation in accordance with a control command transmitted from the main control board 71. The program ROM 75 stores a control programs that are executed by the sub CPU 74. The work RAM 76 is composed of a temporary memory when the control programs are executed in the sub CPU 74.

The sub control board 72 does not include a clock pulse generation circuit, a divider, a random number generator, and a sampling circuit. The sub control board 72 executes random number sampling on an operation program of the sub CPU 74.

The image control circuit 81 includes an image control CPU 82, an image control work RAM 83, an image control program ROM 84, an image ROM 86, a video RAM 87, and an image control IC 88. The image control CPU 82 determines images that are displayed on the upper display portion 3A and the variable display portion 3B on the basis of a parameter set by the sub-micro computer 73 and an image control program (which will be described in detail below).

For example, the image control CPU 82 displays a payout table or a help screen on the upper display portion 3A. The image control CPU 82 variably displays the symbols and stops the symbols in the symbol display areas 111A through 111C, 112A through 112C, 113A through 113C, 114A through 114C, and 115A through 115C of the variable display portion 3B. In the special effect process (S17), the image control CPU 82 displays the effect character image 90 on the variable display portion 3B. In addition, the image control CPU 82 executes an effect using the effect character image 90.

The image control program ROM 84 stores image control programs or various selection tables related to display in the upper display portion 3A and the variable display portion 3B. The image control work RAM 83 functions as a temporary memory when the image control program is executed by the image control CPU 82.

The image control IC 88 forms an image on the basis of contents that are determined by the image control CPU 82. The image control IC 88 outputs the formed image to the upper display portion 3A and the variable display portion 3B. The image ROM 86 stores dot data to form an image. The video RAM 87 functions as a temporary storage device when the image is formed by the image control IC 88.

The internal configuration of the slot machine 1 that has been described above is only exemplary and the invention is not limited thereto. For example, a memory card or a programmable logic device (PLD) may be configured to be attachable and detachable. In this case, the slot machine 1 may be configured such that necessary information is read out from the memory card or the PLD.

The slot machine 1 according to this embodiment of the invention uses, as gaming values, coins, bills, or electronic valuable information (credits) that corresponds to the coins or the bills. However, the gaming values that can be applied to this embodiment of the invention are not limited thereto. For example, the slot machine 1 may use medals, tokens, electronic money, or tickets as the gaming values.

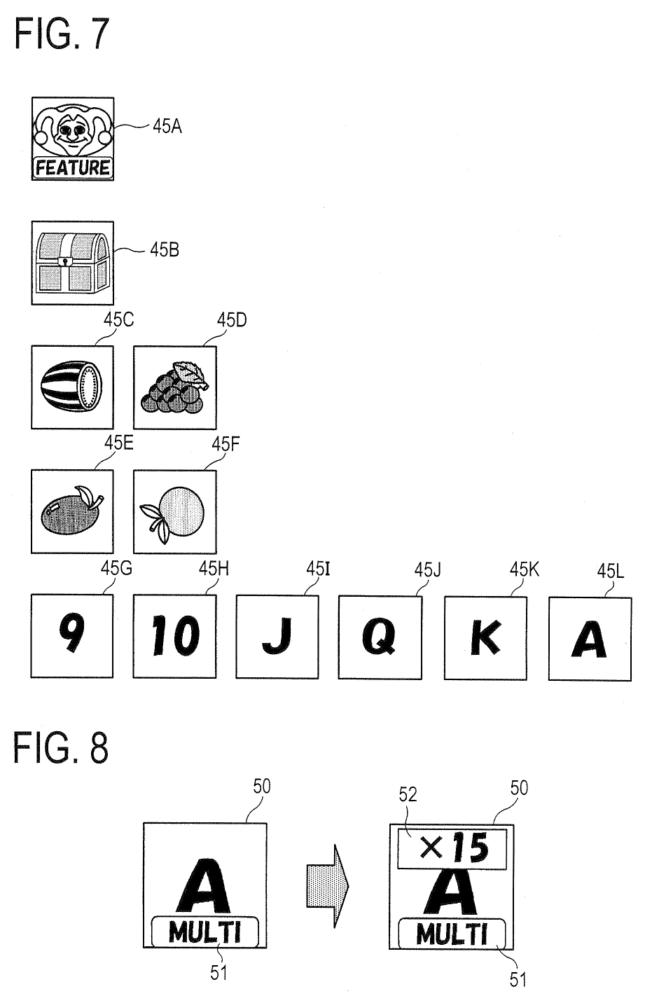

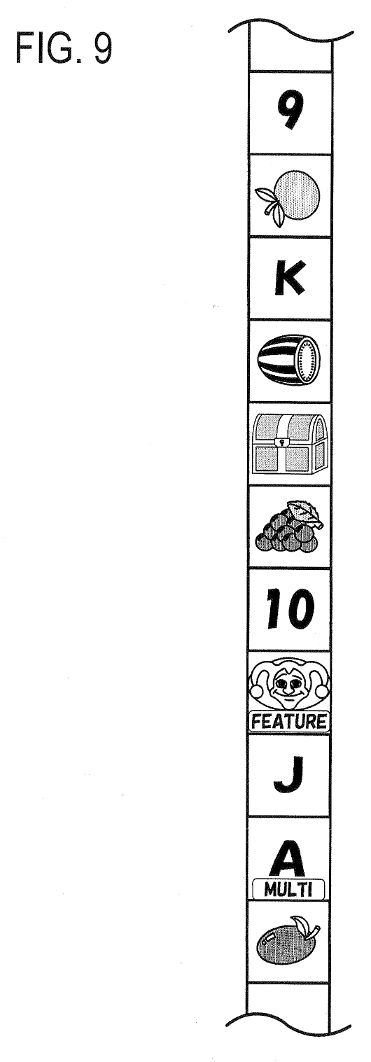

Next, the symbols that are drawn on the reel bands that are variably displayed on the reel display portions will be described in detail with reference to the accompanying drawings. FIG. 7 shows normal symbols that are drawn on the reel bands that are variably displayed on the reel display portions 101 through 105. FIG. 9 shows a reel band (external reel) that is variably displayed on each reel display portion.

As shown in FIGS. 7 and 9, the reel band according to this embodiment includes twelve kinds of normal symbols. The twelve kinds of normal symbols include a feature symbol 45A (FEATURE), a treasure symbol 45B (TREASURE), a watermelon symbol 45C (WATERMELON), a grape symbol 45D (GRAPE), a plum symbol 45E (PLUM), an orange symbol 45F (ORANGE), a “9” symbol 45G (9), a “10” symbol 45H (10), a jack symbol 45I (J), a queen symbol 45J (Q), a king symbol 45K (K), and an ace symbol 45L (A).

Further, the reel band according to this embodiment includes eleven kinds of multi symbols 50 in addition to the above-described twelve kinds of normal symbols (refer to FIG. 7). The eleven kinds of multi symbols 50 include a multi-treasure symbol 50B (MULTI-TREASURE), a multi-watermelon symbol 50C (MULTI-WATERMELON), a multi-grape symbol 50D (MULTI-GRAPE), a multi-plum symbol 50E (MULTI-PLUM), a multi-orange symbol 50F (MULTI-ORANGE), a multi-“9” symbol 50G (MULTI-9), a multi-“10” symbol 50H (MULTI-10), a multi-jack symbol 50I (MULTI-J), a multi-queen symbol 50J (MULTI-Q), a multi-king symbol 50K (MULTI-K), and a multi-ace symbol 50L (MULTI-A).

As shown in FIG. 8, each of the multi symbols 50 is composed of a figure and a multi notification display 51. The figure included in the multi symbol 50 is the same figure as any one of the treasure symbol 45B through the ace symbol 45L. The multi notification display 51 consists of a letter string of “MULTI”.

When the content of the prize is determined, each multi symbols 50 is handled as a the same type of symbol as the normal symbol having the same figure included in the multi symbol 50. As described above, in the slot machine 1 according to this embodiment, a content of a prize that is awarded to a player is determined according to the number of symbols of the same kind that are stopped on the variable display portion 3B. Accordingly, when a multi symbol 50 is stopped on the variable display portion 3B, the content of a prize is determined according to the number of symbols having the same figure (that is, the number of symbols of the same kind) regardless of whether a corresponding symbol is a normal symbol or a multi symbol 50.

For example, the multi-ace symbol 50L shown in FIG. 8 is handled as a symbol of the same kind as the ace symbol 45L. Accordingly, when three ace symbols 45L and one multi-ace symbol 50L are stopped on the variable display portion 3B, the content of the prize is determined to be the content of the prize corresponding to a winning combination related to four ace symbols 45L.

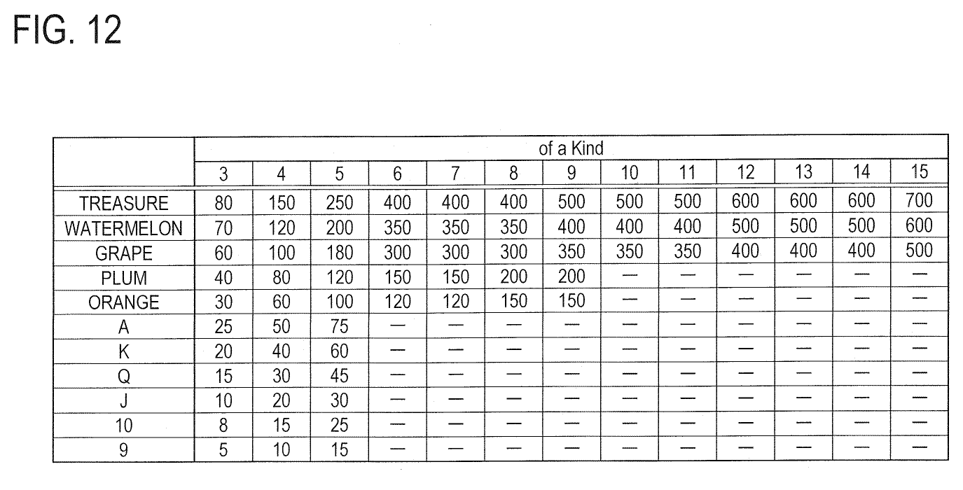

The multi symbol 50 has a function to change the content of the prize to be awarded based on the winning combination (refer to FIG. 12), in a case where the multi symbol 50 is included and a predetermined winning combination (refer to FIG. 12) is established. The changed content of the prize is obtained by multiplying a normal prize based on the winning combination by a predetermined bonus ratio. For example, in a case where three ace symbols 45L and one multi-ace symbol 50L are stopped on the variable display portion 3B and the bonus ratio is “×15”, the content of the prize to be awarded based on the winning combination is equal to a value obtained by multiplying “50 credits” (refer to FIG. 12) by the “bonus ratio: x15”. The value “50 credits” corresponds to the content of the normal prize according to the winning combination related to the four ace symbols 45L.

As shown in FIG. 8, the multi symbol 50 has two kinds of display styles (that is, a first display style and a second display style). In the special effect process (S17) which will be described in detail below, the display style of the multi symbol 50 is changed from the first display style to the second display style.

Here, the first display style is a display style in which only a certain figure (namely, the same figure as a certain kind of normal symbol) and a multi notification display 51 are displayed (refer to a left portion of FIG. 8). As a result, by seeing the first display style, a player can recognize that the symbol is the multi symbol 50 through the existence of the multi notification display 51. Further, the player can specify a kind (ace symbol 45L in the case of FIG. 8) of the normal symbol that is handled as the same kind, on the basis of the figure of the multi symbol 50.

In addition, the second display style is a display style where a certain figure (that is, the same figure as a certain kind of normal symbol), a multi notification display 51, and a bonus ratio display 52 are displayed (refer to a right portion of FIG. 8). The bonus ratio display 52 displays a bonus ratio that is determined in the special effect process (S17) (namely, a bonus ratio by which a normal prize based on a winning combination is multiplied), and notifies the player of the determined bonus ratio. Accordingly, by seeing the bonus ratio display 52 of the second display style, the player can grasp a bonus ratio by which a prize corresponding to a symbol combination that is established including a multi symbol 50 is multiplied.

As shown in FIG. 9, twelve kinds of normal symbols (refer to FIG. 7) and eleven kinds of multi symbols 50 (refer to FIG. 8) are drawn on the reel band in predetermined order. However, the reel band shown in FIG. 9 is merely an example. Accordingly, the sequence in which the symbols are drawn may also be determined arbitrarily. The number of symbols drawn on one reel band is determined arbitrarily, and kinds of to-be-drawn symbols may also be defined arbitrarily.

Next, a game that is executed by the slot machine 1 will be described. In the game that is executed by the slot machine 1 according to this embodiment, all symbols are scatter symbols. That is, in the game according to this embodiment, a prize is awarded on the basis of the number of symbols of the same kind displayed in the symbol display areas 111A through 111C, 112A through 112C, 113A through 113C, 114A through 114C, and 115A through 115C that are arranged in a matrix of 3×5 on the variable display portion 3B (refer to FIG. 12).

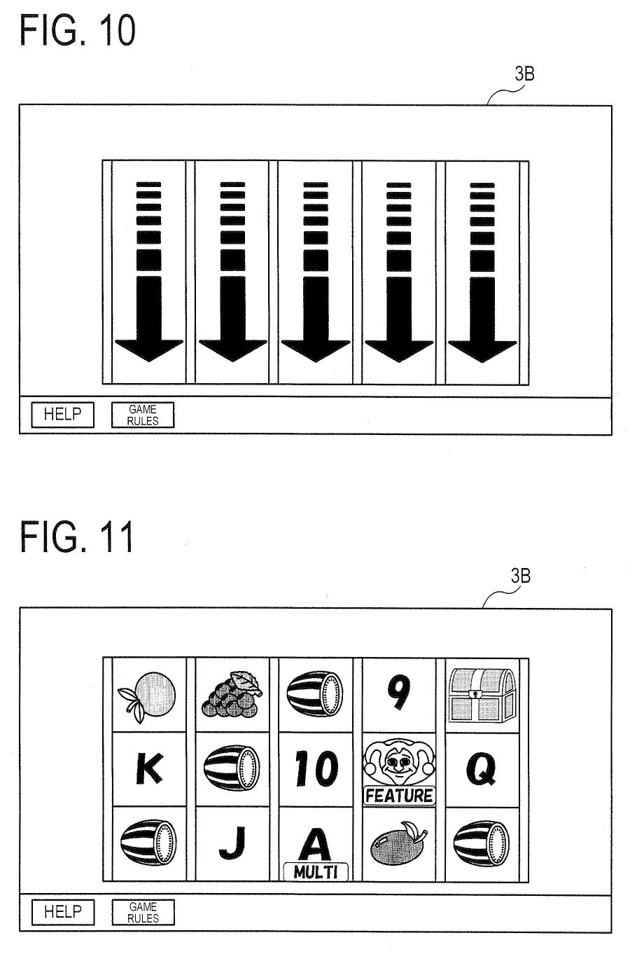

When starting a game in the slot machine 1, the player operates a BET button to set a bet amount. Then, the player presses a start button. As a result, a reel band starts to rotate in each of the reel display portions 101 through 105. That is, a symbol column that is drawn on the reel band is scrolled toward the lower side from the upper side in each of the reel display portions 101 through 105 (refer to FIG. 10).

After the lapse of a predetermined time, the reel band is stopped in each of the reel display portions 101 through 105. Accordingly, a part of the symbol column of each reel band (three symbols among symbols constituting each reel band) is stopped in each of the reel display portions 101 through 105. That is, as shown in FIG. 11, one symbol is stopped respectively in each of the three symbol display areas constituting each reel display portion. As a result, fifteen symbols are stopped on the variable display portion 3B (refer to FIG. 11).

As described above, in the game according to this embodiment, a winning combination is determined on the basis of the number of same symbols that are displayed on the variable display portion 3B. In addition, a prize that corresponds to the winning combination is awarded. When the prize corresponding to the winning combination is awarded, a payout amount that is obtained by multiplying a payout amount corresponding to the winning combination by a bet amount is awarded to the player (refer to FIG. 12). This will be described later.

Next, a winning combination and a content of a prize in the slot machine 1 according to this embodiment will be described in detail with reference to the accompanying drawings. FIG. 12 shows a payout table according to this embodiment.

As shown in FIG. 12, a winning combination and a prize (that is, payout amount) are associated with each other in the payout table. The payout amount in the payout table that is shown in FIG. 12 indicates a payout amount when a bet amount is “1”. That is, when a bet amount is “1”, the payout amount shown in FIG. 12 is paid out. When a bet amount is “2” or more, a payout amount that is obtained by multiplying the bet amount by the payout amount shown in FIG. 12 is paid out.

For example, when the five watermelon symbols 45C are displayed in the fifteen symbol display areas (that is, symbol display areas 111A through 111C, 112A through 112C, 113A through 113C, 114A through 114C, and 115A through 115C) of the variable display portion 3B, a “payout amount that is obtained by multiplying the bet amount by 200 credits” is paid out to the player (refer to FIG. 12).

When the four king symbols 45K are displayed in the fifteen symbol display areas of the variable display portion 3B, a “payout amount that is obtained by multiplying the bet amount by 40 credits” is paid out to the player (refer to FIG. 12). Hereinafter, a payout amount is set for each of the winning combinations in a similar manner, as shown in FIG. 12.

As described above, when a winning combination shown in FIG. 12 is established including a multi symbol 50, the payout amount shown in FIG. 12 is further multiplied by the bonus ratio that is determined in the special effect process (S17). That is, the prize in this case is calculated as the product of the payout amount shown in FIG. 12, the bet amount, and the bonus ratio. Then, the prize calculated is awarded to the player.

When the three or more feature symbols 45A are displayed in the fifteen symbol display areas of the variable display portion 3B, the slot machine 1 awards a bonus game instead of a payout amount to the player. In this embodiment, a so-called free game is awarded as a bonus game. The free game is a game that can be executed without a new credit betted by a player.

When the symbols that are displayed in the fifteen symbol display areas of the variable display portion 3B do not correspond to any of the winning combinations shown in FIG. 12, the game is lost. In this case, the payout amount is not paid out and a prize is not awarded for losing.

Meanwhile, the payout table shown in FIG. 12 is an illustrative example, and the types of the winning combination or the contents of the prize may be set appropriately. For example, the appropriate payout amount may be set as the contents of the prize. Further, bonus games different from the free game (for example, a selective bonus game and the like) or JACKPOT may be provided as the prize in the slot machine 1. Furthermore, a plurality of payout tables may be provided and a payout table may be selected according to a payout rate.

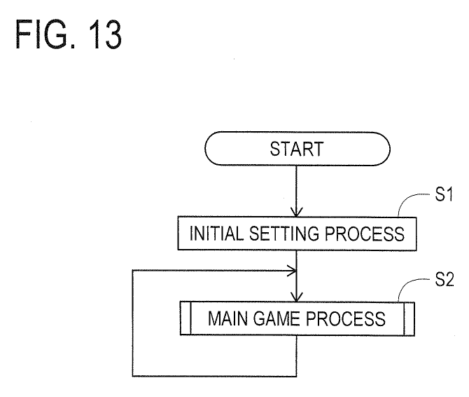

Next, a main control program that is executed in the slot machine 1 according to this embodiment will be described in detail with reference to the accompanying drawings. FIG. 13 is a flowchart illustrating the main control program.

First, when the power switch is turned on (upon power on), the main control board 71 and the sub control board 72 are activated and the controller 41 executes an initial setting process (S1). In the initial setting process (S1), the main CPU 42 executes the BIOS stored in the ROM 44 and expands the compressed data incorporated in the BIOS in the RAM 43. In executing the BIOS that was expanded in the RAM 43, the main CPU 42 carries out a diagnosis and initialization of the different types of peripheral devices. Further, the main CPU 42 writes the game programs and the like from the ROM 44 into the RAM 43 to acquire payout rate setting data and country identification information. While executing the initial setting process (S1), the main CPU 42 also carries out an authentication process with respect to each program.

When the initial setting process (S1) is terminated, the main CPU 42 executes a main game process (S2). In the main game process (S2), the main CPU 42 sequentially reads out the game program and the like from the RAM 43 and executes the game program. The main game process (S2) is executed, thereby the game is executed in the slot machine 1 according to the present embodiment. Meanwhile, the main game process (S2) is repeatedly executed while power is being supplied to the slot machine 1.

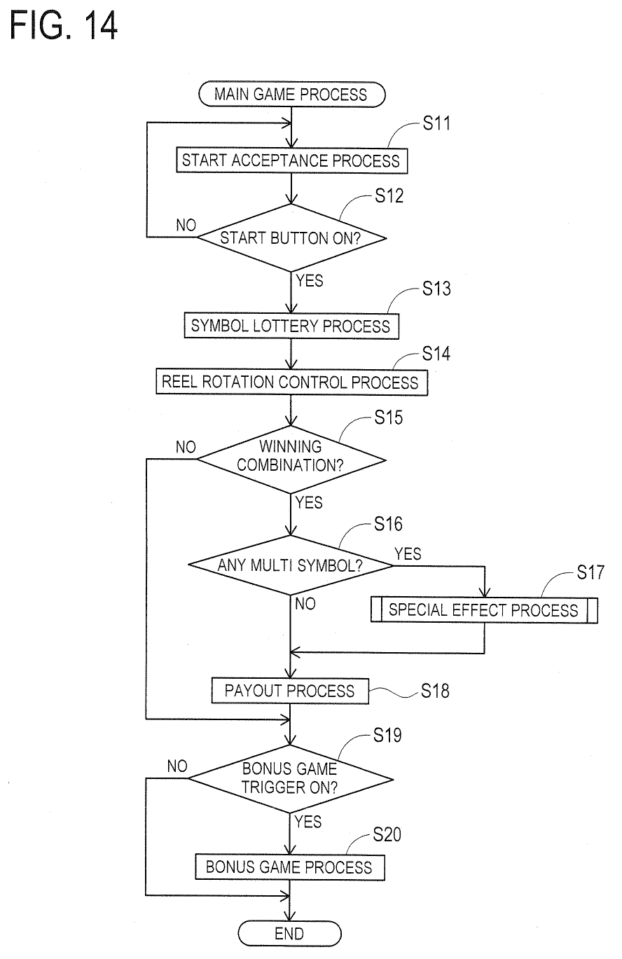

Next, a main game process program that is executed by the main game process (S2) will be described in detail with reference to the accompanying drawings. FIG. 14 is a flowchart illustrating the main game process program in the slot machine 1 according to this embodiment. Each program that is illustrated in the flowchart to be described below is stored in the ROM 44 or the RAM 43 that is included in the slot machine 1, and executed by the main CPU 42.

As shown in FIG. 14, first, the main CPU 42 executes a start acceptance process (S11). In the start acceptance process (S11), a player inserts coins and executes a bet operation using the BET button in the operation buttons 26.

After shifting to S12, the main CPU 42 judges whether a start button in the operation buttons 26 is pressed or not. At this time, the main CPU 42 judges whether the start button is pressed or not on the basis of the existence or non-existence of a signal that is generated when the start button is pressed. If the start button is pressed (S12: YES), the main CPU 42 subtracts a bet amount set on the basis of the bet operation from a credit amount that the player currently possesses. In addition, the main CPU 42 stores the subtraction result as bet information in the RAM 43. If the subtraction of the credit amount and the storage of the bet information are completed, the main CPU 42 shifts the process to S13. On the other hand, if the start button is not pressed (S12: NO), the main CPU 42 returns to the start acceptance process (S11). As a result, the player can execute operations, such as correction of the bet amount or the like.

After shifting to S13, the main CPU 42 executes a symbol lottery process. In the symbol lottery process (S13), the main CPU 42 executes a lottery program that is stored in the RAM 43 in order to sample a random number value within a predetermined random number value range. In addition, the main CPU 42 determines symbols to be stopped on middle portions of the reel display portions (that is, symbol display areas 111B, 112B, 113B, 114B, and 115B), on the basis of the sampled random number value and a table.

The symbols that are determined by the symbol lottery process (S13) and stopped in the individual symbol display areas correspond to a game result according to the embodiment of the invention. When a multi symbol 50 is stopped as a symbol to be stopped in the symbol display areas, a game result that indicates “awarding a prize that corresponds to a multi symbol 50” is fixed. A payout amount that corresponds to the winning combination including a multi symbol 50 (that is, a content of a prize that corresponds to a winning combination), etc. is determined by a bonus ratio determination process (S31), etc., which will be described in detail below.

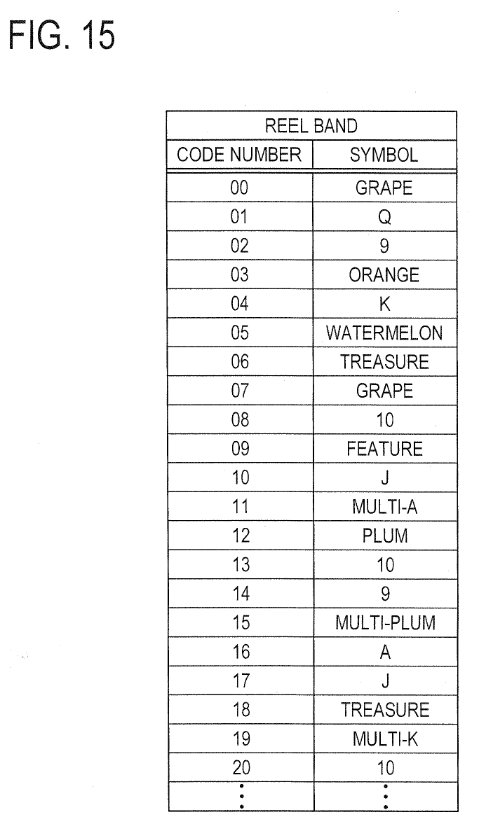

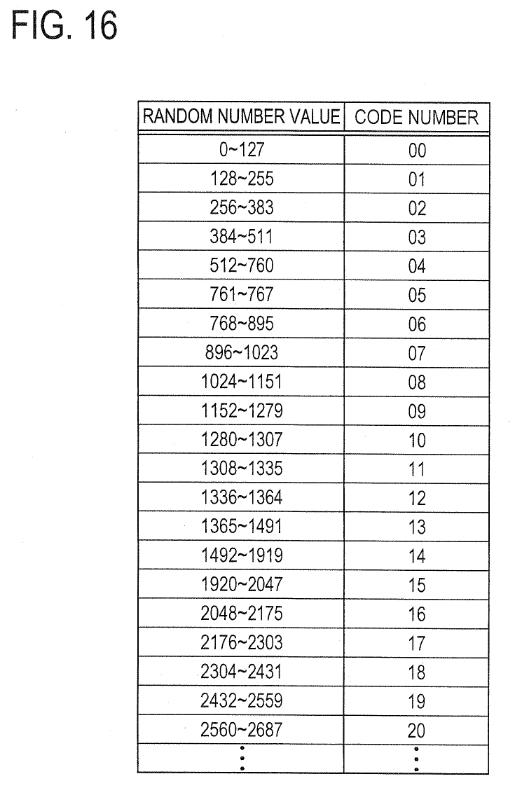

Next, a process using the random number value during the symbol lottery process (S13) will be described in detail with reference to the accompanying drawings. FIG. 15 shows an example of a table associating symbols drawn on a reel band and code numbers. FIG. 16 shows an example of a table associating random number values and code numbers.

The table (for example, refer to FIG. 15) associating the symbols and the code numbers is associated with each of the reel display portions 101 through 105.

As described above, in the symbol lottery process (S13), the main CPU 42 executes a lottery program in order to sample a random number value within a predetermined random number value range (for example, a range of 0 to 65535). Then, the main CPU 42 determines a code number on the basis of the sampled random number value and the table associating the random number values and the code numbers (for example, refer to FIG. 16). If the code number is determined, the main CPU 42 determines a symbol to be stopped at a middle portion of the reel display portion, on the basis of the code number and the table associating the symbols and the code numbers (refer to FIG. 15).

For example, when the reel band shown in FIG. 15 is used in the reel display portion 101 and a random number value “1136” is sampled, the main CPU 42 determines a code number “08” on the basis of the random number value “1136” and the table shown in FIG. 16. In addition, the main CPU 42 determines a symbol to be stopped in the symbol display area 111B as a “10” symbol 45H, on the basis of the code number “08” and the table shown in FIG. 15.

The process using the random number value in the symbol lottery process (S13) is not limited to a process using the random number value, the table associating the random number values and the code numbers (for example, refer to FIG. 16), and the table associating the symbols and the code numbers (refer to FIG. 15).

For example, the sampled random number values and the symbols may be directly associated with each other. The sampled random number values and the winning combinations may be directly associated with each other. Then, the symbols to be stopped may be determined on the basis of the table associating the random number values and the winning combinations. In this case, when a random number value that is not associated with a winning combination is sampled, the game is lost.

Next, processes in the main game process program following the symbol lottery process (S13) will be described with reference to FIG. 14 again.

After the symbol lottery process (S13) is terminated, the main CPU 42 executes a reel rotation control process (S14). In the reel rotation control process (S14), the main CPU 42 variably displays a reel band on each of the reel display portions 101 through 105 at a predetermined speed. Then, the main CPU 42 determines an effect pattern (such a pattern as image display on the variable display portion 3B or audio output from the speaker 34, etc.) with respect to a unit game. In addition, the main CPU 42 starts the effect based on the determined effect pattern by controlling the sub control board 72, etc. The unit game is a game that is executed by a series of processes from starting the variable display of each of the reel bands to stopping all of the reel bands.

If a predetermined time has elapsed, the main CPU 42 stops the reel bands on the reel display portions 101 through 105 in predetermined order. As a result, one symbols is stopped on the fifteen symbol display areas (that is, symbol display areas 111A through 111C, 112A through 112C, 113A through 113C, 114A through 114C, and 115A through 115C) of the variable display portion 3B. In regards to stop of the reel bands on the reel display portions, all the reel display portions may be stopped at one time. Then, all the reel display portions may be sequentially stopped at a time interval.

Next, the stop of the symbols will be described in detail on the basis of the specific example of the reel display portion 101 that has been described in the symbol lottery process (S13). According to the above-described specific example, the “10” symbol 45H (code number: 8) determined in the symbol lottery process (S13) is stopped in the symbol display area 111B that is a middle portion of the reel display portion 101. In this case, the grape symbol 45D (code number: 7) is displayed in the symbol display area 111A that is an upper portion of the reel display portion 101. In addition, the feature symbol 45A (code number: 9) is displayed in the symbol display area 111C that is a lower portion of the reel display portion 101.

After the reel rotation control process (S14), the main CPU 42 judges whether or not symbols that are stopped on the variable display portion 3B correspond to a winning combination (S15). Specifically, the main CPU 42 judges whether or not the symbols correspond to a winning combination on the basis of a code number of each of the reel display portions 101 through 105 stored in the RAM 43.

When the multi symbol 50 is included in the symbols that are stopped on the variable display portion 3B, the main CPU 42 judges whether or not the symbols correspond to a winning combination while handling the multi symbol 50 (for example, multi-ace symbol 50L) as a normal symbol (for example, ace symbol 45L) having the same figure.

If a winning combination is established (S15: YES), the main CPU 42 calculates a payout amount corresponding to the winning combination on the basis of the payout table (refer to FIG. 12). Then, the main CPU 42 shifts the process to S16. On the other hand, if a winning combination is not established (S15: NO), the main CPU 42 shifts the process to S19. When starting a game continuously next time or later, the processes of S11 and later are executed again.

After shifting to S16, the main CPU 42 judges whether or not a multi symbol 50 is included in a specific kind of symbols that correspond to a winning combination (hereinafter, referred to as winning symbol group). Specifically, the main CPU 42 executes the above judgment process on the basis of the code numbers of the individual reel display portions determined in the symbol lottery process (S13). If a multi symbol 50 is included in the winning symbol group (S16: YES), the main CPU 42 shifts the process to the special effect process (S17). On the other hand, if a multi symbol 50 is not included in the winning symbol group (S16: NO), the main CPU 42 shifts the process to S18.

After shifting to S17, the main CPU 42 executes the special effect process. In the special effect process (S17), the main CPU 42 executes an effect by displaying the effect character image 90 on the variable display portion 3B. During the execution of the effect, the main CPU 42 changes a display style of the multi symbol 50 included in the winning symbol group from the first display style to the second display style. The special effect process (S17) will be described in detail below. When the special effect process (S17) is terminated, the main CPU 42 shifts the process to S18.

After shifting to S18, the main CPU 42 executes a payout process. In the payout process (S18), the main CPU 42 pays out to the player a payout amount corresponding to the winning combination determined by the process of S15 or S17. After the payout process (S18) is terminated, the main CPU 42 shifts the process to S19.

In S19, the main CPU 42 judges whether a bonus game trigger is established or not. Specifically, the main CPU 42 refers to the code numbers of the reel display portions 101 through 105 stored in the RAM 43. In addition, the main CPU 42 judges “whether three or more feature symbols 45A are stopped in the fifteen symbol display areas that constitute the variable display portion 3B”.

if three or more feature symbols 45A are stopped and a bonus game trigger is established (S19: YES), the main CPU 42 shifts the process to a bonus game process (S20). On the other hand, if the bonus game trigger is not established (S19: NO), the main CPU 42 terminates the main game process program. As described above, the main game process program is executed again at the same time as the termination.

After shifting to S20, the main CPU 42 executes the bonus game process. In the bonus game process (S20), the main CPU 42 first displays a plurality of choices on the variable display portion 3B. Then, the main CPU 42 receives a player's choice from the plurality of choices. Each of the choices is associated with an execution condition of a bonus game respectively. The execution condition includes the number of free games to be executed, etc. If the player selects one choice from the plurality of choices, the main CPU 42 executes a free game under the execution condition that is associated with the selected choice. After the free game is executed the predetermined number of times, the main CPU 42 terminates the bonus game process. Then, the main CPU 42 terminates the main game process program. Also in this case, the main game process program is executed again at the same time as the termination.

Since the process that is related to the free game is already well-known, the detailed description of the bonus game process (S20) will not be given here.

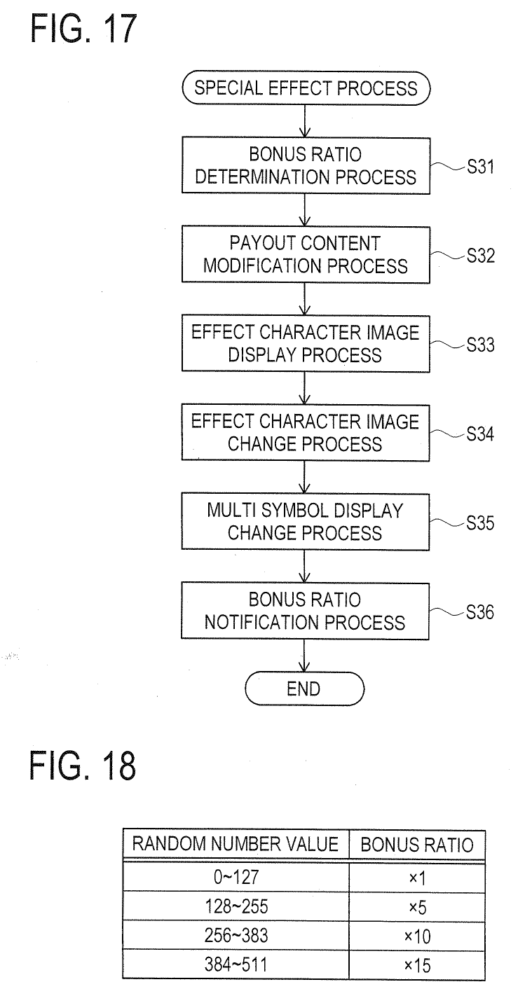

Next, a special effect process program that is executed in the special effect process (S17) will be described in detail with reference to the accompanying drawings. FIG. 17 is a flowchart illustrating the special effect process program according to this embodiment.

As described above, if a multi symbol 50 is included in the winning symbol group (S16: YES), the main CPU 42 shifts the process to the special effect process (S17). In addition, the main CPU 42 starts to execute the special effect process program. At this time, the multi symbol 50 that is displayed on the variable display portion 3B is displayed according to the first display style.

After starting the execution of the special effect process program, the main CPU 42 executes a bonus ratio determination process (S31). In the bonus ratio determination process (S31), the main CPU 42 samples one random number value within a predetermined random number value range. In addition, the main CPU 42 determines a bonus ratio related to the multi symbol 50, on the basis of the sampled random number value and the bonus ratio determination table (refer to FIG. 18). After storing the determined bonus ratio in the RAM 43, the main CPU 42 shifts the process to S32.

In the bonus ratio determination process (S31), the main CPU 42 synthesizes an image of the multi symbol according to the second display style on the basis of an image of the multi symbol according to the first display style and an image indicating the determined bonus ratio, through the sub control board 72.

The bonus ratio determination table that is used in the bonus ratio determination process (S31) will be described in detail with reference to the accompanying drawings.

As shown in FIG. 18, in the slot machine 1 according to this embodiment, four kinds of bonus ratios are defined. That is, when a multi symbol 50 is included in the winning symbol group, one of four kinds of bonus ratios (that is, “×1”, “×5”, “×10”, and “×15”) is associated with the corresponding multi symbol. In addition, in the bonus ratio determination table, a predetermined random number value range is set for each of the bonus ratios. Accordingly, the main CPU 42 can determine a bonus ratio that is associated with the multi symbol 50, on the basis of a random number value range to which the sampled random number value belongs.

After shifting to S32, the main CPU 42 executes a payout content modification process. In the payout content modification process (S32), the main CPU 42 multiplies a payout amount, which corresponds to the winning symbol group set in S15, by the bonus ratio that is determined by the bonus ratio determination process (S31). In addition, the main CPU 42 modifies the payout amount that corresponds to the winning symbol group. After storing the modified payout amount that corresponds to the winning symbol group in the RAM 43, the main CPU 42 shifts the process to S33.

Next, the payout content modification process (S32) will be described in detail on the basis of the specific example that is shown in FIGS. 1 and 19 through 22. In the case of the specific example, two ace symbols 45L and one multi-ace symbol 50L are stopped on the variable display portion 3B. Accordingly, in this case, a winning combination related to three ace symbols 45L is established. At a point of time when the process in S15 is executed, a payout amount based on the winning combination related to three ace symbols 45L (that is, 25 credits) is set as a prize that corresponds to the winning symbol group.

In the case of the specific example, during the payout content modification process (S32), the main CPU 42 multiplies the “25 credits” corresponding to the winning symbol group by the bonus ratio determined in the bonus ratio determination process (S31). That is, the main CPU 42 modifies a payout amount with respect to the winning symbol group into a “payout amount obtained by multiplying the 25 credits by the determined bonus ratio”. For example, when the “bonus ratio: ×15” is determined in the bonus ratio determination process (S31), the main CPU 42 modifies the payout amount related to the winning symbol group into “375 credits”.

In the following S33, the main CPU 42 executes an effect character image display process. In the effect character image display process (S33), the main CPU 42 displays an effect character image 90 depicting a captain of a pirate ship on the variable display portion 3B. After displaying the effect character image 90 on the variable display portion 3B, the main CPU 42 shifts the process to S34.

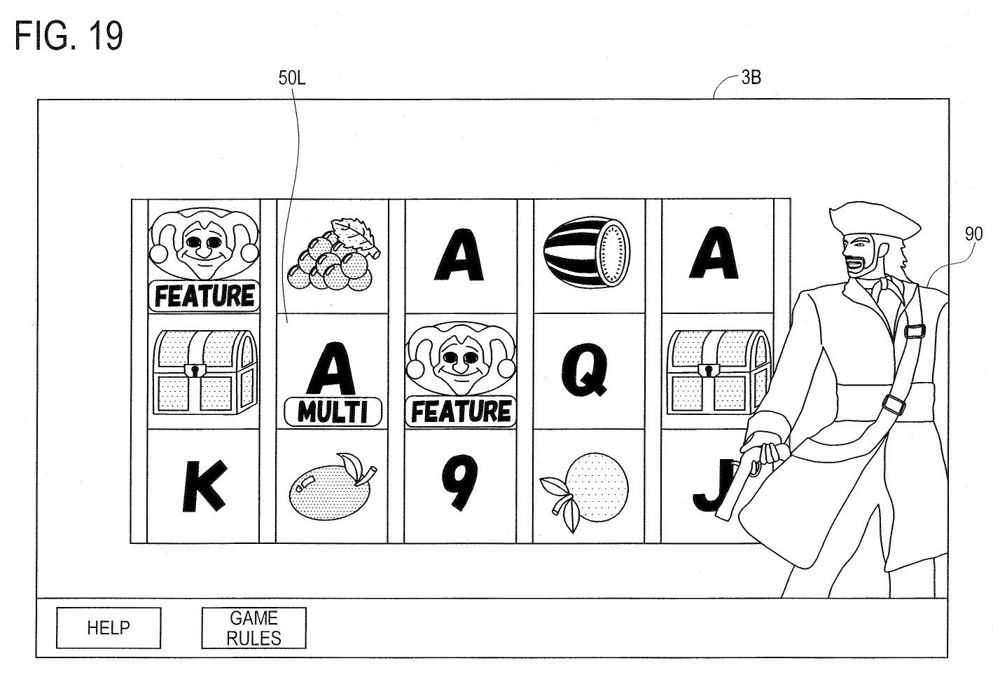

Next, a display style of the variable display portion 3B in the effect character image display process (S33) will be described in detail with reference to FIG. 19.

As shown in FIG. 19, in the effect character image display process (S33), an effect character image 90 is displayed in a state where a captain of a pirate ship is taking out a gun.

In the effect character image display process (S33), the effect character image 90 is displayed while being overlapped with a part of the symbol display areas 115B and 115C that constitute the reel display portion 105 (refer to FIG. 19).

As shown in FIG. 19, a treasure symbol 45B is stopped in the symbol display area 115B. The right arm of the captain of the pirate ship that is the effect character image 90 is displayed in the symbol display area 115B to slightly overlap with the symbol display area 115B. In this case, in the symbol display area 115B, a lower right corner of the figure of the treasure symbol 45B is slightly covered by the right arm of the effect character image 90. However, most of the figure of the treasure symbol 45B (for example, 80% or more of the figure) can be seen (refer to FIG. 19).

In the symbol display area 115C, a jack symbol 45I is stopped. In addition, a portion of the image of the captain of the pirate ship that is the effect character image 90 (that is, the front end of a gun that the captain holds) is displayed in the figure of the jack symbol 45I to slightly overlap with the figure. Even in this case, the area covered by the portion of the effect character image 90 is only a portion of the figure of the jack symbol 45I. That is, in the symbol display area 115C, most of the figure of the jack symbol 45I (for example, 80% or more of the figure) can be seen (refer to FIG. 19).

Accordingly, even though the effect character image display process (S33) is executed to display an effect character image 90 while being overlapped with a part of symbol display area, most of the figure of the stopped symbol (for example, 80% or more of the figure) can be seen. In the effect character image display process (S33), even when the effect character image 90 is displayed, the slot machine 1 hardly lowers the visibility of each symbol stopped on the variable display portion 3B. As a result, even in this case, a player can surely grasp a game result.

After shifting to S34, the main CPU 42 executes an effect character image change process. In the effect character image change process (S34), the main CPU 42 changes the display style of the effect character image 90 by executing animation display of the effect character image 90. After changing the display style of the effect character image 90 displayed on the variable display portion 3B by the animation display, the main CPU 42 shifts the process to S35.

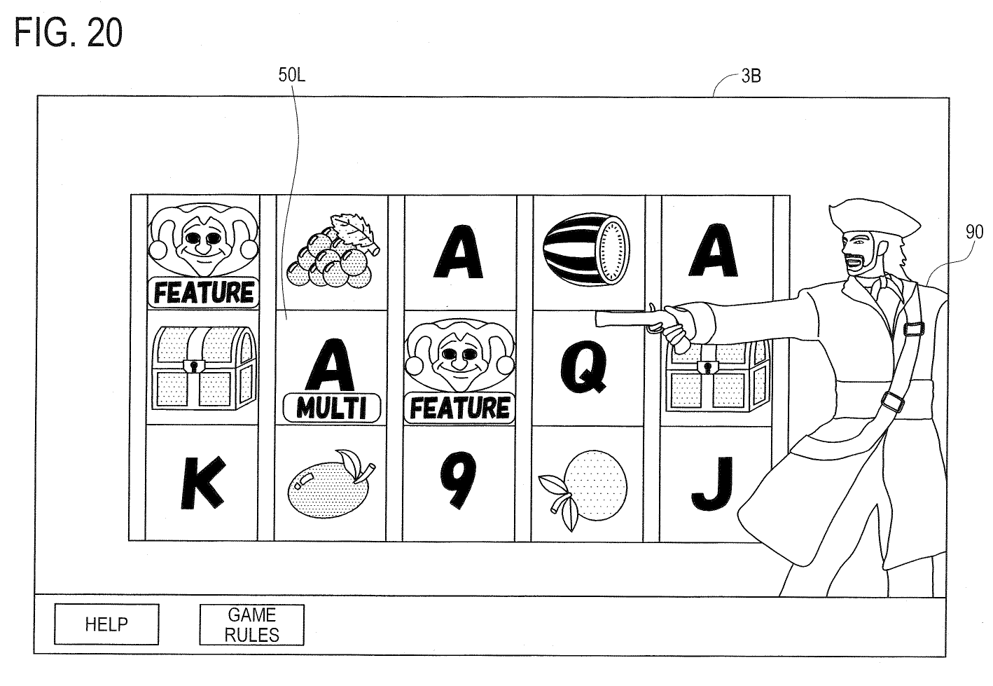

Here, a display style of the variable display portion 3B in the effect character image change process (S34) will be described in detail with reference to FIG. 20.

As shown in FIG. 20, in the effect character image change process (S34), by the animation display, a display style of the effect character image 90 is changed from a state where a captain of a pirate ship is taking out a gun to a state where the captain of the pirate ship aims a gun at a target.

During the effect character image change process (S34), the effect character image 90 is displayed while being overlapped with a part of the symbol display area 114B and the symbol display areas 115A, 115B, and 115C that constitute the reel display portion 105 (refer to FIG. 20).

As shown in FIG. 20, a queen symbol 45J is stopped in the symbol display area 114B. In addition, the gun that the captain of the pirate ship holds as the effect character image 90 is displayed in the symbol display area 114B to slightly overlap with the symbol display area 114B. In this case, in the symbol display area 114B, the gun of the effect character image 90 is displayed to cover an upper portion of the symbol display area 114B, but does not overlap with the figure of the queen symbol 45J stopped in the symbol display area 114B. That is, the queen symbol 45J stopped in the symbol display area 114B is not covered at all by the effect character image 90. Accordingly, even when a display style of the effect character image 90 is changed by the effect character image change process (S34), the slot machine 1 does not lower the visibility of the symbol stopped in the symbol display area 114B.

In this case, an ace symbol 45L is stopped in the symbol display area 115A. In addition, the upper portion of the right arm of the captain of the pirate ship that is the effect character image 90 is displayed in the symbol display area 115A to slightly overlap with the symbol display area 115A. In this case, in the symbol display area 115A, the upper portion of the right arm of the effect character image 90 is displayed to cover the lower portion of the symbol display area 115A. However, the upper portion of the right arm of the effect character image 90 does not overlap at all with the figure of the ace symbol 45L stopped in the symbol display area 115A. Accordingly, even when a display style of the effect character image 90 is changed by the effect character image change process (S34), the slot machine 1 does not lower the visibility of the symbol stopped in the symbol display area 116A.

In addition, a treasure symbol 45B is stopped in the symbol display area 115B. The lower portion of the right arm of the captain of the pirate ship that is the effect character image 90 is displayed in the symbol display area 115B to slightly overlap with the symbol display area 115B. In this case, in the symbol display area 115B, the upper end of the figure of the treasure symbol 45B is slightly covered by the lower portion of the right arm of the effect character image 90. However, most of the figure of the treasure symbol 45B (for example, 80% or more of the figure) can be seen (refer to FIG. 20). Accordingly, even when a display style of the effect character image 90 is changed by the effect character image change process (S34), the slot machine 1 does not lower the visibility of the symbol that is stopped in the symbol display area 115B.

As shown in FIG. 20, a jack symbol 45I is stopped in the symbol display area 115C. In addition, a portion of the image of the captain of the pirate ship that is the effect character image 90 (the hem of the clothes of the captain) is displayed in the symbol display area 115C to slightly overlap with the symbol display area 115C. However, the figure of the jack symbol 45I stopped in the symbol display area 115C does not overlap with a portion of the image of the effect character image 90. Accordingly, in the symbol display area 115C, the figure of the jack symbol 45I can be seen (refer to FIG. 20).

As described above, even when a display style of the effect character image 90 is changed in the effect character image change process (S34), the slot machine 1 does not lower the visibility of the symbol stopped in the symbol display area with which the effect character image 90 is displayed to overlap. Accordingly, in the effect character image change process (S34), a player can surely grasp a game result.

After shifting to S35, the main CPU 42 executes a multi symbol display change process. In the multi symbol display change process (S35), the main CPU 42 executes an effect of when changing the display style of the multi symbol S0 included in the winning symbol group by using the effect character image 90. After starting the effect, the main CPU 42 shifts the process to S36.

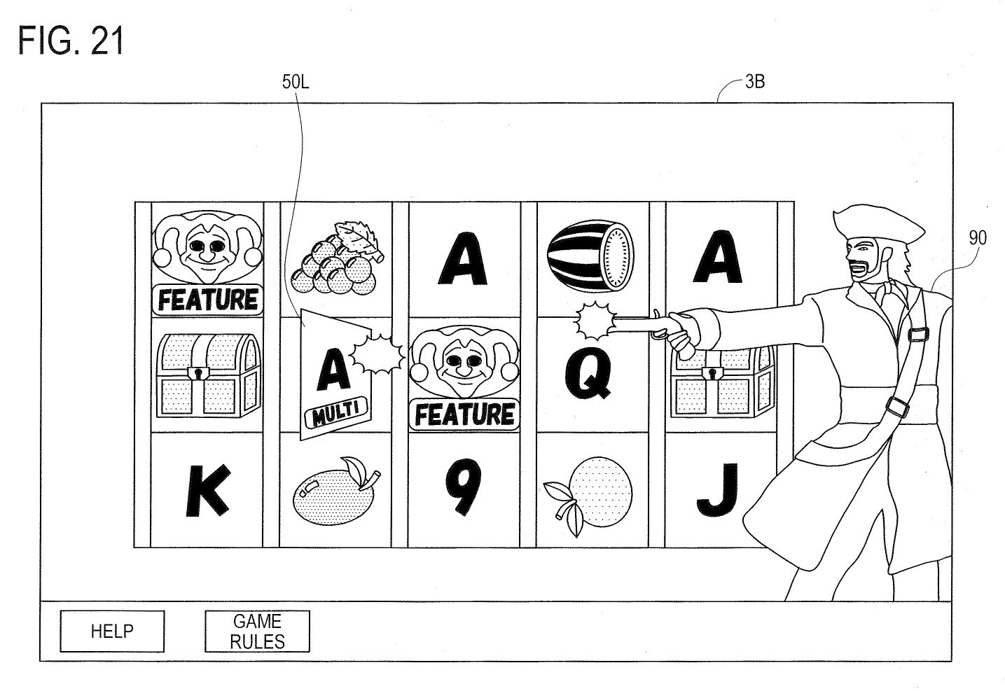

Now, a display style of the variable display portion 3B in the multi symbol display change process (S35) will be described in detail with reference to FIG. 21.

As shown in FIG. 20, when the effect character image change process (S34) is terminated (that is, when shifting to the multi symbol display change process), the effect character image 90 is displayed in a display style that shows the captain of the pirate ship aiming a gun at a target in the variable display portion 3B.

After shifting to the multi symbol display change process (S35), the main CPU 42 first displays, on the variable display portion 3B, an animation image in which the captain of the pirate ship aiming a gun at a target fires (refer to FIG. 21). In conjunction with the animation of the effect character image 90, the main CPU 42 displays an animation image in the symbol display area in which the multi symbol 50 is stopped. The animation image is such that the captain fires and hits a panel with the multi symbol 50 drawn thereon and the panel rolls.

As shown in FIG. 21, the display style of the effect character image 90 is not basically changed from the display style in the effect character image change process (S34). Accordingly, similarly to the effect character image change process (S34), the slot machine 1 does not lower the visibility of the symbol stopped in each symbol display area in the multi symbol display change process (S35).

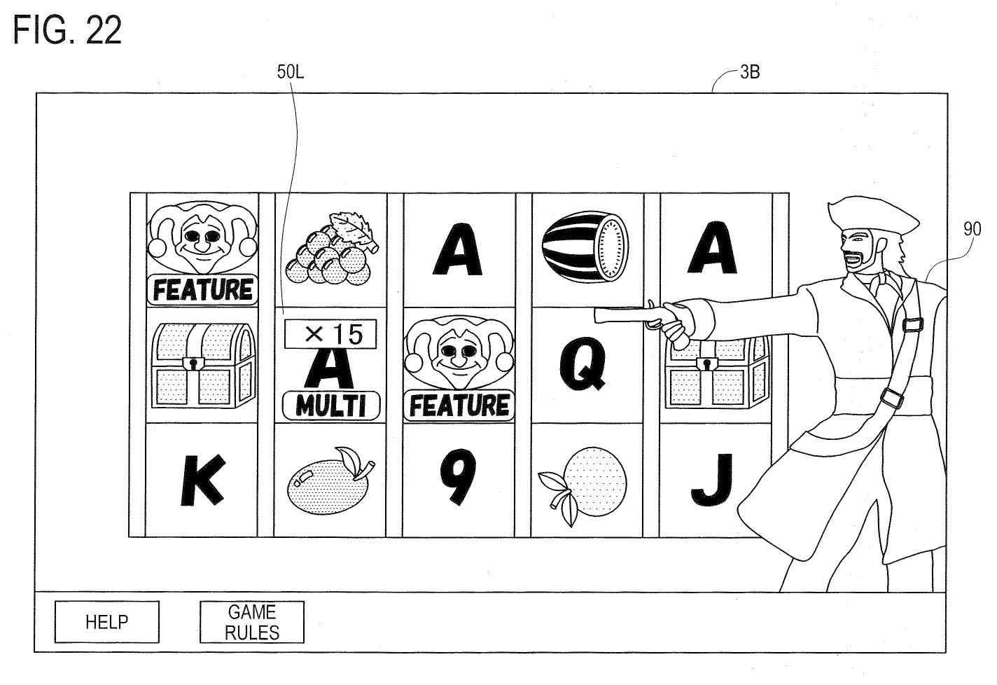

In S36, the main CPU 42 executes a bonus ratio notification process. In the bonus ratio notification process (S36), the main CPU 42 reads out synthesized image data of the multi symbol 50 related to the second display style that is synthesized in S31. In addition, the main CPU 42 displays the synthesized image data in the symbol display area where the multi symbol 50 is stopped (refer to FIG. 22). After changing the display style of the multi symbol 50 included in the winning symbol group to the second display style, the main CPU 42 terminates the special effect process program.

Next, a display style of the variable display portion 3B in the bonus ratio notification process (S36) will be described in detail with reference to FIG. 22.

As described above, in the multi symbol display change process (S35), the main CPU 42 displays an animation image in which a panel with a multi symbol 50 (in this case, multi-ace symbol 50L) is drawn thereon rotates (refer to FIG. 21).

In the bonus ratio notification process (S36), the main CPU 42 displays the multi symbol 50 (for example, multi-ace symbol 50L) in the second display style (refer to FIG. 22).

As shown in FIGS. 8 and 22, a bonus ratio display 52 is added to the multi symbol 50 of the second display style. Accordingly, the player can grasp the determined bonus ratio by seeing the multi symbol 50 displayed in the second display style. As a result, the player can grasp a payout amount related to the winning symbol group, on the basis of a normal payout amount related to the winning symbol group and the determined bonus ratio.

In the bonus ratio notification process (S36), the display style of the effect character image 90 is not basically changed from the display styles in the effect character image change process (S34) and the multi symbol display change process (S35) (refer to FIGS. 20 through 22). Accordingly, similarly to the effect character image change process (S34) and the multi symbol display change process (S35), even in the case of the bonus ratio notification process (S35), the slot machine 1 does not lower the visibility of the symbol stopped in each symbol display area.

As described above, by executing the special effect process (S17), the slot machine 1 can change the display style of the stopped multi symbol 50 that belongs to the winning symbol group from the first display style to the second display style, while executing an effect using the effect character image 90. In the special effect process (S17), the slot machine 1 can enhance an entertainment property based on the “notification of the bonus ratio” by the effect in the multi symbol display change process (S35). Accordingly, if the winning combination includes a multi symbol 50, the slot machine 1 can enhance an entertainment property in a game of the slot machine 1.

In the special effect process (S17), the slot machine 1 executes an effect by displaying the effect character image 90. In this case, the effect character image 90 is displayed while being overlapped with a part of the symbol display area, and is used for an effect. Accordingly, it is possible to achieve various types of effect expressions. As a result, the slot machine 1 can enhance an interest of a player.

Further, the effect character image 90 may be displayed to slightly overlap with the figure of the stopped symbol, and at least, most of the figure (for example, 80% or more of the figure) is displayed in a visible state. Accordingly, even when the slot machine 1 according to this embodiment executes an effect using the effect character image 90, the slot machine 1 can secure the visibility of the symbol stopped in each symbol display area.

When there are a plurality of multi symbols 50 that constitute a winning combination (that is, multi symbols 50 included in a winning symbol group), the processes of S31 through S36 are repeatedly executed as many times as the number of multi symbols 50 included.

As described above, the slot machine 1 according to this embodiment variably displays and stops the symbols. Then, the slot machine 1 according to this embodiment awards a prize on the basis of the number of symbols of the same kind that are stopped as a game result.

In the reel rotation control process (S14), the slot machine 1 notifies the player of the game result by stopping the symbols determined in the symbol lottery process (S13) on the variable display portion 3B.

If a predetermined winning combination (refer to FIG. 12) including a multi symbol 50 is established in the stopped symbols (S15: YES and S16: YES), the slot machine 1 executes the special effect process (S17).

In the special effect process (S17), the slot machine 1 displays the effect character image 90 on the variable display portion 3B. In addition, the slot machine 1 executes an effect of changing the display style of the stopped multi symbol 50 from the first display style to the second display style, by using the effect character image 90. The slot machine 1 changes a payout that corresponds to a winning combination including the multi symbol 50 (that is, payout that corresponds to a winning symbol group) to a value obtained by multiplying the payout by a bonus ratio associated with the multi symbol 50 (S32). Accordingly, the slot machine 1 can enhance an entertainment property related to the payout that corresponds to the winning symbol group by executing the special effect process (S17).

In this case, the effect character image 90 is displayed while being overlapped with a part of the symbol display areas (for example, symbol display areas 115A through 115C) where the symbols are stopped (refer to FIGS. 1 and 19 through 22). The effect character image 90 is displayed in the symbol display area while being overlapped with only a very small portion of the figure of the stopped symbol. In other words, the effect character image 90 covers only the very small portion of the figure of the symbol. That is, in the corresponding symbol display area, most of the figure of the symbol (80% or more of the figure) is maintained in a visible state without being covered by the effect character image 90. Accordingly, the slot machine 1 does not disturb the grasp of a game result notified by the stop of the symbol by the player. In addition, the slot machine 1 can enhance an interest of a player by executing the effect using the effect character image 90.

The slot machine 1 can execute an effect based on the effect character image 90 using not only a portion outside the symbol display areas but also a portion of the symbol display areas under the predetermined restriction. Accordingly, the slot machine 1 can secure a lot of areas that can be used for an effect based on the effect character image 90. As a result, the slot machine 1 executes various types of effects, thereby further enhancing an interest of a player.

In the special effect process (S17), the slot machine 1 changes the display style of the multi symbol 50 stopped in the symbol display area from the first display style to the second display style (S33 through S36), in conjunction with the animation display of the effect character image 90. Accordingly, since the display style of the multi symbol is changed, the slot machine 1 can visually improve “an entertainment property according to the multi symbol 50”.

In addition, the multi symbol 50 of the second display style has the bonus ratio display 52. Accordingly, the player can grasp the bonus ratio that corresponds to the multi symbol 50 by changing the display style of the multi symbol 50 in the special effect process (S17). As a result, the slot machine 1 can provide an entertainment property of “amazement by the bonus ratio corresponding to the multi symbol 50” to the player, by changing the display style of the multi symbol 50 in the special effect process (S17).

It should be noted that the present invention is not limited to the above-described embodiments, and various changes and modifications can be made without departing from the sprit and scope of the invention.

For example, in this embodiment, the character image depicting the captain of the pirate ship is used as the effect character image 90, but the invention is not limited to the image thereof. If the figure of the stopped symbol can be maintained in a visible state (for example, a state in which 80% or more of the figure can be seen), the size and the location of the effect character image 90 may be arbitrarily selected.

The effect when the display style of the multi symbol 50 is changed from the first display style to the second display style is not limited to the effect according to the above-described embodiments, and various effect styles can be used. That is, various effects can be used, as long as the various effects correspond to the effects of changing the display style of the multi symbol 50 from the first display style to the second display style.

In this embodiment, the variable display portion 3B is configured using a liquid crystal panel, but may be configured using mechanical reels and a transparent liquid crystal display device arranged on a front of the mechanical reels. That is, the slot machine 1 may be configured as a so-called hybrid-typed gaming machine. In this case, a figure drawn on the mechanical reel may be viewed through the transparent liquid crystal display. In addition, it is preferable that a hybrid gaming machine be configured as follows: display windows of which the number is equal to the number of mechanical reels are provided to a transparent liquid crystal display, and figure drawn on the mechanical reels can be seen through the display windows. In the case of using the mechanical reels, rotation and stop operations of the mechanical reels are controlled by a motor (not shown).

In the slot machine 1 according to this embodiment, a “free game” is awarded as a bonus game, but the invention is not limited thereto. In the invention, all types of prizes that can be given as a bonus may be arbitrarily applied. For example, it is possible to apply various types of bonus games, such as a selective bonus game.

The invention can also be realized as a game method that executes the above-described processes. Further, the invention can be realized as a program that allows a computer to execute the game method and a recording medium where the program is stored.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
a display that displays a symbol display portion on which plural kinds of symbols are variably displayed and stopped; and
a processor that executes:
(a) a process of starting variable-display of the plurality of symbols, stopping the variable-display of the plurality of symbols and display symbols among from the plurality of symbols in the symbol display portion;
(b) a process of determining one game result;
(c) a process of, when a predetermined condition is satisfied, displaying an effect image for an effect on the display with overlapped with a part of the symbol display portion while keeping each of the symbol s stopped at the process (a) visible;
(d) a process of executing an effect using the effect image displayed while being overlapped with a part of the symbol display portion; and
(e) a process of awarding a prize based on the game result currently determined.

2. A gaming machine comprising:
a display that displays a symbol display portion on which plural kinds of symbols are variably displayed and stopped; and
a processor that executes:
(a) a process of starting variable-display of the plurality of symbols, stopping the variable-display of the plurality of symbols and display symbols among from the plurality of symbols in the symbol display portion;
(b) a process of determining one game result;
(c) a process of, when a predetermined condition is satisfied, displaying an effect image for an effect on the display with overlapped with a part of the symbol display portion while keeping each of the symbol s stopped at the process (a) visible;
(d) a process of executing an effect for changing a display style of the symbols stopped at the process (a) to a display style determined depending on the game result, by using the effect image overlapped with the part of the symbol display portion at the process (c);
(e) a process of awarding a prize based on the game result currently determined.

3. A gaming machine comprising:
a display that displays a symbol display portion on which plural kinds of the symbols including a special symbol are variably displayed and stopped; and
a processor that executes:
(a) a process of starting variable-display of the plurality of symbols, stopping the variable-display of the plurality of symbols and display symbols among from the plurality of symbols in the symbol display portion;
(b) a process of determining one game result;
(c) a process of, when a specific combination including the specific symbol is stopped on the symbol display portion, displaying an effect image for an effect on the display with overlapped with a part of the symbol display portion while keeping each of the symbols stopped at the process (a) visible;
(d) a process of executing an effect for changing a display style of the special symbols stopped at the process (a) to a display style determined depending on the game result, by using the effect image overlapped with the part of the symbol display portion at the process (c); and
(e) a process of awarding a prize based on the game result currently determined.
